(19) United States
(12) Patent Application Publication
(10) Pub. No.: US 2015/0339604 A1
(43) Pub. Date: Nov. 26, 2015

(54) METHOD AND APPLICATION FOR BUSINESS INITIATIVE PERFORMANCE MANAGEMENT

(71) Applicant: International Business Machines Corporation, Armonk, NY (US)

(72) Inventors: Iqbal Alikhan, Grandville, MI (US); Pu Huang, Yorktown Heights, NY (US); Tarun Kumar, Mohegan Lake, NY (US); Margaret A. Marx, West Hartford, CT (US); Bonnie K. Ray, Nyack, NY (US); Dharmashankar Subramanian, White Plains, NY (US); Sanjay Tripathi, Ridgefield, CT (US); Shanchi Zhan, White Plains, NY (US)

(73) Assignee: International Business Machines Corporation, Armonk, NY (US)

(21) Appl. No.: 14/282,000

(22) Filed: May 20, 2014

(51) Int. Cl. G06Q 10/06

(52) U.S. Cl. CPC G06Q 10/0635

(57) ABSTRACT

A method including, for a set of historical and/or ongoing business initiatives, determining key negative and positive performance factors by a computer from a structured taxonomy of negative and positive performance factors stored in a memory; modeling at least one of the performance factors for the ongoing business initiative or a new business initiative at at least one level of the hierarchical taxonomy. The key negative and positive performance factors are modeled based, at least partially, upon a likelihood of occurrence of the key negative performance factors during the business initiative, and based, at least partially, upon potential impact of the key performance factors on the business initiative. The method further includes providing the modeled performance factors in a report to a user, where the report identifies the modeled performance factors, and the potential impact of the at least one modeled performance factor.

### BACKGROUND

1. Technical Field

The exemplary and non-limiting embodiments relate generally to management of a business initiative and, more particularly, to modeling.

2. Brief Description of Prior Developments

Organizations typically have a number of business initiatives underway simultaneously; each in different stages of deployment. One example is that of client project delivery. Multiple client engagements may be ongoing at any given point in time, each having potential risks that could impact its profitability. To reduce these risks, decisions must be made regarding mitigating actions. Additionally, there exists a pipeline of projects being pursued for future engagements. Often, business processes have been established to group projects into a portfolio and subsequently track and manage performance of both individually selected projects and the entire project portfolio over time. The portfolio under management may span the organization and consist of projects of varying strategic intents and operational complexity. Quantitative targets are pre-established at both the project and portfolio levels, with business success defined and measured by attainment of targets for both. For instance, revenue and cost represent commonly used financial targets, while customer satisfaction may be a more relevant target for business initiatives in a services organization. No matter the specifics of the target metrics, the challenge is to optimally balance resource investment across the entire portfolio of current and potential projects to ensure that the targets are achieved.

In many organizations, tracking and management of initiative portfolios are carried out using spreadsheet or presentation templates that are passed around among the team, with little upfront investment in common data definitions, formats, or structured data collection systems. While this type of management process supports ongoing discussions centered on current initiatives, it does not enable the business to clearly identify patterns of risks arising for subsets of the initiatives or to easily retrieve and structure information that might be useful for anticipating risks to future initiatives. It also does not support quantification of the impact of different risks on performance targets. It is well known that the prediction of risk events by experts tends to exhibit multiple types of bias, such as anchoring bias or recency bias, in which likelihood of future risk event occurrence is predicted to be greater for those events that are under discussion and have occurred most recently in the past.

### SUMMARY

The following summary is merely intended to be exemplary. The summary is not intended to limit the scope of the claims.

In accordance with one aspect, a method includes, for a set of historical and/or ongoing business initiatives, determining key negative and positive performance factors by a computer from a structured taxonomy of negative and positive performance factors stored in a memory, where the structured taxonomy is a hierarchical taxonomy; modeling at least one of the key negative and positive performance factors for the ongoing business initiative or a new business initiative by the computer at at least one level of the hierarchical taxonomy based, at least partially, upon a likelihood of occurrence of the key performance factors during the business initiative, and potential impact of the key performance factors on the business initiative; and providing at least one of the modeled performance factors in a report to a user, where the report identifies the at least one modeled performance factor, and the potential impact of the at least one modeled performance factor.

In accordance with another aspect, an apparatus comprises at least one processor; and at least one non-transitory memory including computer program code, the at least one memory and the computer program code configured to, with the at least one processor, cause the apparatus at least to, for a set of historical and/or ongoing business initiatives, determine key negative and positive performance factors from a structured taxonomy of negative and positive performance factors stored in the memory, where the structured taxonomy is a hierarchical taxonomy; model at least one of the key negative and positive performance factors for the ongoing business initiative or a new business initiative at at least one level of the hierarchical taxonomy based, at least partially, upon a likelihood of occurrence of the key performance factors during the business initiative, and potential impact of the key performance factors on the business initiative; and provide at least one of the modeled performance factors in a report to a user, where the report identifies the at least one of the modeled performance factor, and the potential impact of the at least one modeled performance factor.

In accordance with another aspect, a non-transitory program storage device readable by a machine is provided, tangibly embodying a program of instructions executable by the machine for performing operations, the operations comprising, for a set of historical and/or ongoing business initiatives, determining key negative and positive performance factors by a computer from a structured taxonomy of negative and positive performance factors stored in a memory, where the structured taxonomy is a hierarchical taxonomy; modeling at least one of the key negative and positive performance factors for the ongoing business initiative or a new business initiative by the computer at at least one level of the hierarchical taxonomy based, at least partially, upon a likelihood of occurrence of the key performance factors during the business initiative, and potential impact of the key performance factors on the business initiative; and providing at least one of the modeled performance factors in a report to a user, where the report identifies the at least one modeled performance factor, and the potential impact of the at least one modeled performance factor.

### BRIEF DESCRIPTION OF THE DRAWINGS

The foregoing aspects and other features are explained in the following description, taken in connection with the accompanying drawings, wherein:

FIG. 1 is a block diagram of a computing device and a server in communication via a network, in accordance with an exemplary embodiment of the instant invention;

FIG. 2 depicts a networked environment according to an exemplary embodiment of the present invention;

FIG. 3 is an example of a portion of a business initiative taxonomy;

FIG. 4 is an example of a portion of a business initiative taxonomy;

FIG. 5 is a diagram illustrating a modeled tree from the business initiative taxonomy shown in FIG. 4;

FIG. 6 is an example report showing risks and mitigation actions;

FIG. 7 is an example of a decision-tree is for an illustrative risk factor;

FIG. 8 is a sketch of an example system architecture built specifically to manage initiatives;

FIG. 9 is a diagram illustrating an example method;

FIG. 10 is an example of some performance factors in a first layer of an example hierarchical taxonomy;

FIG. 11 is an example of some performance factors in a second layer of a first one of the performance factors shown in FIG. 10;

FIG. 12 is an example of some performance factors in a third layer of performance factors stemming from performance factors shown in FIGS. 10-11;

FIG. 13 is an example of some performance factors in a third layer of performance factors stemming from performance factors shown in FIGS. 10-11;

FIG. 14 is an example of some performance factors in an example hierarchical taxonomy;

FIG. 15 is an example of a report from data and the example hierarchical taxonomy of FIGS. 10-14.

### DETAILED DESCRIPTION OF EMBODIMENTS

Modern organizations support multiple projects, initiatives, and processes typically have specific performance targets associated with each. Actual performance is monitored with respect to these targets, and positive and negative factors contributing to the performance are captured; often in the form of unstructured text. Usually lacking in practice, however, is a systematic way to structure and analytically exploit such documented observations across multiple initiatives within the organization. Careful structuring of such information is a fundamental enabler for analytics to detect patterns across initiatives, such as the propensity of certain types of initiatives to exhibit specific problems and the impact these problems tend to have on targets. Identification of such patterns is essential for driving actions to improve the execution of future initiatives. Described herein is an analytics-supported process and associated tooling to fill this gap. The process may include several steps, including data capture, predictive modeling, and reporting.

Modern organizations often have a large portfolio of initiatives underway at any given point. The term “initiative” is used to denote a set of activities that have a common objective, a corresponding set of specific performance metrics, and an associated multi-period business case that specifies the planned targets for each metric of interest in each time period in the plan. In an example embodiment, the associated business case might not be a multi-period business case. In practice, organizations operate in an uncertain, dynamic environment, and it is common to witness a gap (positive or negative) between the actual measured performance and its corresponding target in the business plan. In this context, the term “performance factor” is used to denote any performance-related influence that may be experienced over the life time of the initiative having potential to impact the initiative performance metrics beneficially or adversely.

It is also common in practice for initiatives to be periodically reviewed to assess their actual performance against targets. These reviews typically result in textual reports documenting observed negative and positive factors that affected the initiative in the corresponding time period. A natural set of analytical questions arise regarding what can be learned from the documented information in order to enable more successful execution of future initiatives. For example:
Are initiatives of a certain type predisposed to certain types of negative performance factors?
Which performance events are responsible for the majority of the impacts to an initiative performance metric of interest?
Based on what we have seen historically, what are the most likely performance challenges a given new initiative will encounter, and when?
   Careful structuring of key observations captured across multiple initiatives may be fundamental to enable analytical methods that can be used to answer the above questions.

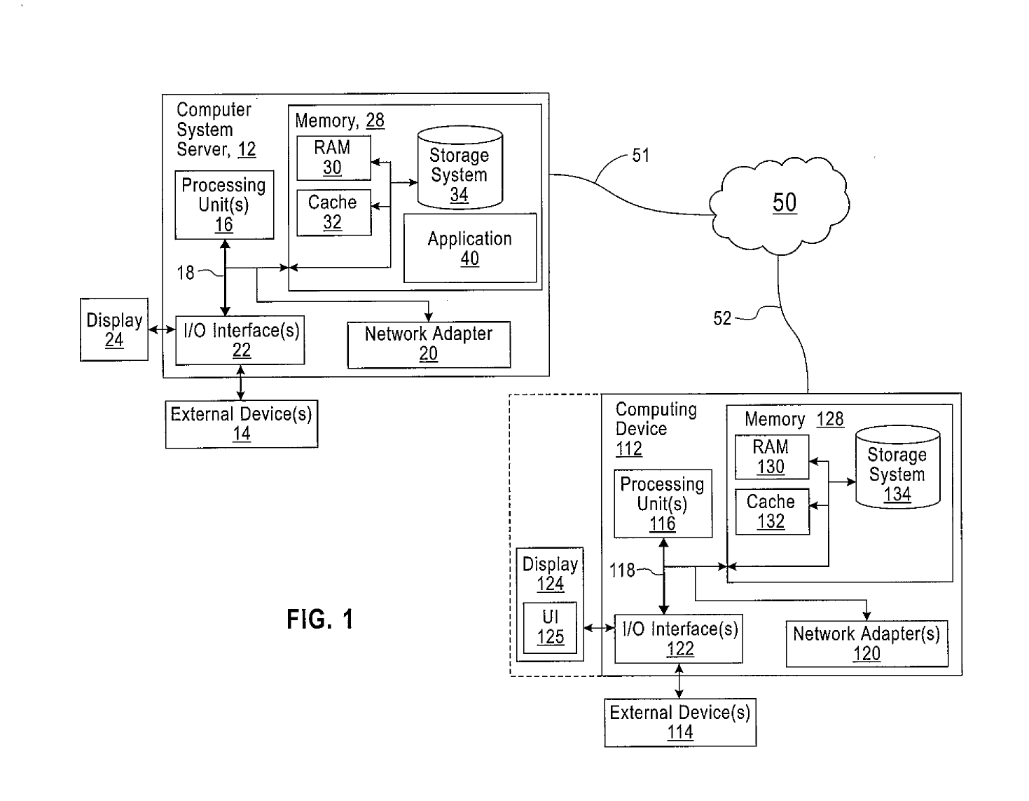

Reference is made to FIG. 1, which shows a block diagram of a computing device and a server in communication via a network, in accordance with an exemplary embodiment. FIG. 1 is used to provide an overview of a system in which exemplary embodiments may be used and to provide an overview of an exemplary embodiment of instant invention. In FIG. 1, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to one or more processing units 16. Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computer system/server 12 typically includes a variety of computer system readable media, such as memory 28. Such media may be any available media that is accessible by computer system/server 12, and such media includes both volatile and non-volatile media, removable and non-removable media. System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a removable, non-volatile memory, such as a memory card or “stick” may be used, and an optical disk drive for reading from or writing to a removable, non-volatile optical disk such as a CD-ROM, DVD-ROM or other optical media can be provided. In such instances, each can be connected to bus 18 by one or more I/O (Input/Output) interfaces 22.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via, e.g., I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The computing device 112 also comprises a memory 128, one or more processing units 116, one or more I/O interfaces 122, and one or more network adapters 120, interconnected via bus 118. The memory 128 may comprise non-volatile and/or volatile RAM, cache memory 132, and a storage system 134. Depending on implementation, memory 128 may include removable or non-removable non-volatile memory. The computing device 112 may include or be coupled to the display 124, which has a UI 125. Depending on implementation, the computing device 112 may or may not be coupled to external devices 114. The display may be a touchscreen, flatscreen, monitor, television, projector, as examples. The bus 118 may be any bus suitable for the platform, including those buses described above for bus 18. The memories 130, 132, and 134 may be those memories 30, 32, 34, respectively, described above. The one or more network adapters 120 may be wired or wireless network adapters. The I/O interface(s) 122 may be interfaces such as USB (universal serial bus), SATA (serial AT attachment), HDMI (high definition multimedia interface), and the like. In this example, the computer system/server 12 is connected to the computing device 112 via network 50 and links 51, 52. The computing device 112 connects to the computer system/server 12 in order to access the application 40.

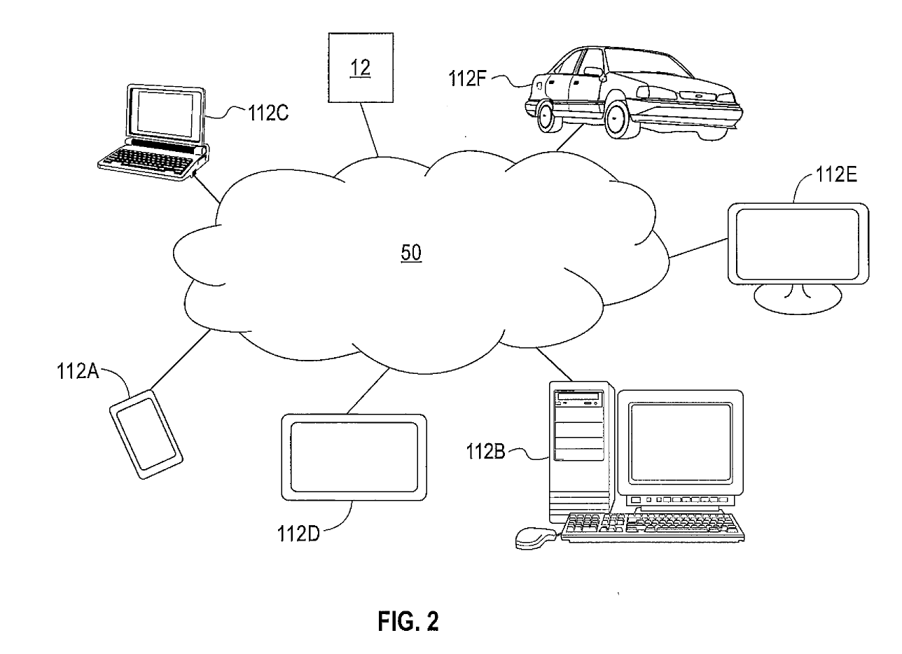

Turning to FIG. 2, a networked environment is illustrated according to an exemplary embodiment of the present invention. In this example, the computer system/server 12 is shown separate from network 50, but could be part of the network. There are A through E different computing devices 112 shown: smartphone 112A, desktop computer 112B, laptop 112C, tablet 112D, television 112E, and automobile computer system 112E. Not shown but equally applicable are set-top boxes and game consoles. These are merely exemplary and other devices may also be used.

As described herein, an analytics-supported process, such as the application 40, and associated tooling may be provided, such as via the devices 12, 112, for systematic monitoring of one or more initiatives in order to provide business insights. The process may comprise:
using a purpose-built, hierarchical taxonomy to capture, in a structured format, performance factors contributing to on-going initiative performance,
running predictive performance models at one or more levels of the performance factor hierarchy on individual initiatives or portfolios of initiatives, and
generating interactive reports to provide multiple views of on-going initiative performance, predicted factors likely to affect performance of a new initiative or ongoing initiative and their expected impact, and actions used successfully in the past to mitigate those factors negatively impacting performance.

Each initiative may be described by a “fingerprint” of characteristics spanning multiple dimensions. Predictive modeling may be used to estimate the likelihood and impact of potential performance factors that an initiative may encounter, based on correlation of the initiative “fingerprint” to historically observed performance events. The analysis results may be made available to project managers and contributors via a web-based portal. Additionally, observed factors, and their relative impact on any gap observed between the actual and target performance metrics, may be captured periodically from subject matter experts (SMEs) and used to continuously improve the performance factor likelihood and impact models.

While much previous literature on project risk management exists, much of it focuses on estimating schedule risk, cost risk or resource risk. Although there does exist literature on estimating risks associated with financial performance of an initiative, it typically relies on direct linkage of an initiative fingerprint to financial outcomes, or prediction of future performance from current financial performance for on-going initiatives. Other work focuses on updating performance factor likelihoods as information changes over a project's lifecycle. Features of an example as described herein are different in that a two-step approach is described comprising:
first, predicting likely performance factor that a given initiative may encounter, and
second, estimating the conditional impact of the identified performance factors based on historically observed financial impact of these factors in similar other initiatives.

The analytic techniques used in this example approach, and associated data-driven decision support system, may be standardly adopted in an enterprise setting.

The new risk and performance management process and associated tooling, as described by the example embodiments described herein, was designed to orient the relevant business processes towards a more fact-based and analytics-driven approach. Foundational elements of this fact-based approach may consist of three parts: 1) Data specification, 2) Data collection, and 3) Performance factor prediction and action. Part one consists of creating a structured taxonomy for classification of positive and negative performance factors that impact initiative performance, along with a set of high-level characteristics (or descriptors) of a business initiative that are known prior to the start of an initiative, and are potentially useful for predicting patterns of performance over an initiative's lifecycle. The data specifications are carried out before data can be collected in a useful format (i.e. the issues or risks of interest are defined) along with the initiative descriptors. Once these data elements are specified, data collection can begin. The impact of each risk factor on initiative performance is captured. Finally, for new initiatives, collected data is used to predict risks most likely to occur in new initiatives and recommend mitigation actions to reduce the likelihood and/or impact of a predicted risk. Taken together, these steps provide a foundation upon which predictive and pro-active risk management activities can be built.

Risk Taxonomy

A well-defined taxonomy of risk factors is foundational to data collection. A taxonomy allows discrete events affecting performance to be conceptualized, classified and compared across initiatives and over time.

Developing a useful taxonomy is not necessarily straightforward. An iterative approach to taxonomy development may be taken; as it is often not feasible from a business perspective to construct a taxonomy and then wait for some length of time to collect enough data for analysis. An initial taxonomy may be created for categorizing business initiative risks through manual examination of status reports from a set of historical initiatives, and also discussions that are conducted with SMEs to identify key factors for inclusion in the taxonomy. A team of researchers and consultants may peruse numerous historical performance reports, for example, to glean insights and structure them into a comprehensive and consistent set of underlying performance drivers. Once an initial set of performance drivers is constructed, the team may also elicit perspectives from a broad range of experts, ranging from portfolio managers and project executives to functional leaders, to ensure relevance and completeness of the taxonomy. Input from both documents and experts may be synthesized and reconciled to form a standard taxonomy that is applicable to data capture across multiple initiatives. A risk factor may be defined and included in the taxonomy, for example, only if the corresponding risk event had been experienced in the context of a historical initiative. The taxonomy may be organized according to functional areas of the business, such as Sales or Marketing for example, thereby facilitating linkage between performance risk factors and actions. Incorporation of multiple business attributes, such as geography, business unit or channel, may also be important to support different views of the data for different business uses.

Note that risk taxonomy may be designed to capture factors that manifest themselves in the performance of the initiative, such as Sales Capacity risk related to Employee Retention for example; not necessarily underlying “root causes” of a risk, such as non-competitive employee salaries. While distinguishing between a root cause and a risk event is not always clear cut, a risk event may be defined as something that could be linked directly to an impact on the quantitative outcome of the initiative.

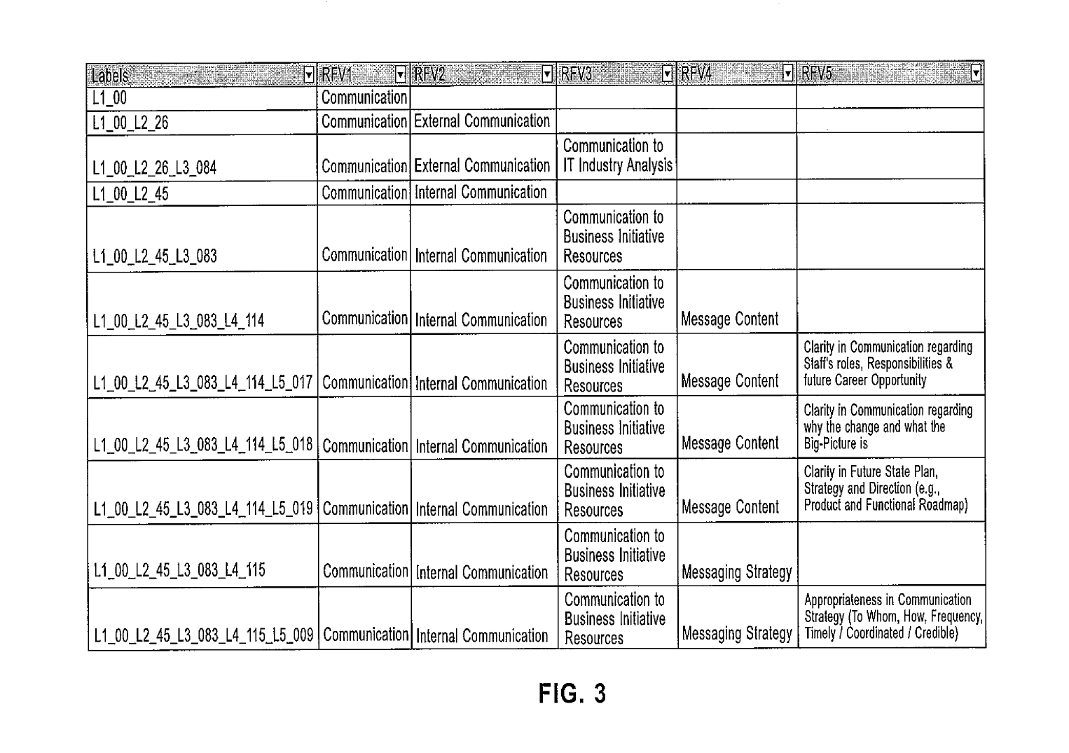

FIG. 3 shows one example of a taxonomy.

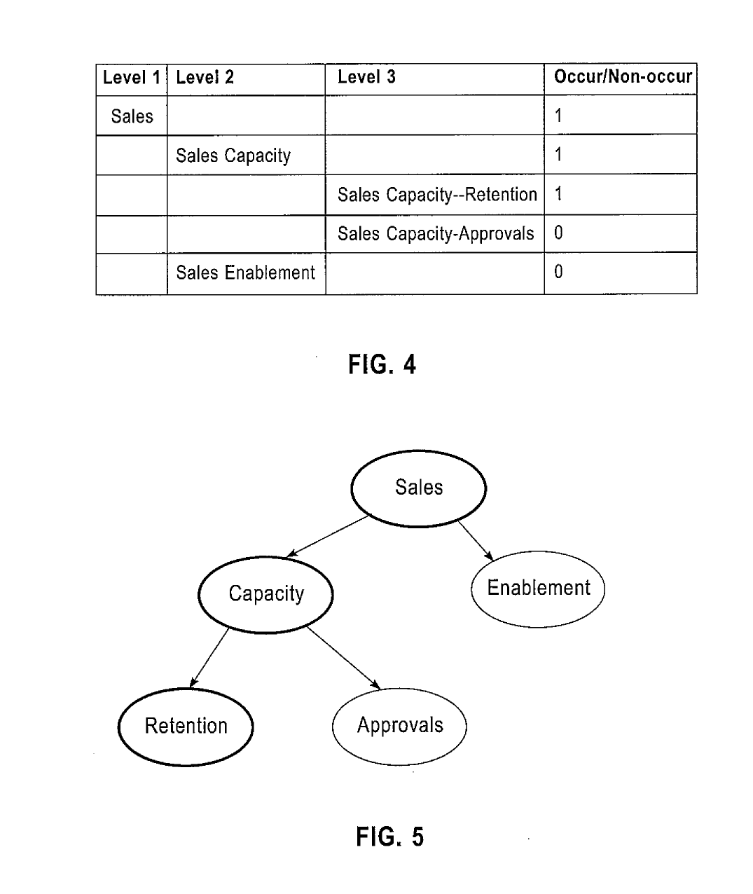

One issue that arises in developing a suitable taxonomy is that of granularity such as, for example, how to best balance specificity of risk factors versus sufficiency of observations across projects to permit statistical learning of patterns of risk occurrence. A similar issue arises with respect to planning mitigations actions, which are often devised by business planners to address general descriptions of risk factors within a given functional area. To address this challenge, a hierarchical tree structure for each functional area may be used, where the deeper one goes from the root-node in any given tree, the more specialized and granular the description of the risk factor. An example risk factor hierarchy is shown in FIG. 5 for the “Sales” functional area for the taxonomy shown in FIG. 4. FIG. 5 is an example of a hierarchical performance factor taxonomy tree, where an observation is recorded at the node “Retention”. The nodes outlined in bold indicate a specific path of the risk taxonomy tree.

The nodes outlined in bold indicate a specific path of the risk taxonomy tree consisting most generally of Sales-related risk factors, which may be further specified as risk factors related to Sales Capacity, such as the number of available sales resources for example, and even more specifically, Sales Capacity-Retention issues, where Retention refers to the ability of an organization to retain sales people. A Sales risk factor recorded at the node “Retention” also has an implied interpretation as both a “Sales-Capacity” risk, and a “Sales” risk. Thus, the risk taxonomy takes the form of a forest of trees, such as a union of multiple disjointed trees for example, ∪ₖ₌₁^{k=K}Tₖ, where each tree Tₖ represents a performance-related functional area, k=1, . . . K. Since each risk factor may have either an adverse or a beneficial impact on initiative performance, we maintain two copies of the taxonomy, wherein each tree Tₖ is replaced by two copies, namely, Tₖ⁺ and Tₖ⁻. In other words, a positive risk factor counts as a risk factor and a negative risk factor counts as a distinct, separate risk factor, with separate predictive likelihood models built for each and separate impacts estimated for each. The distinction between positive and negative performance, in this example embodiment, was based entirely on whether the factor was observed to have a positive or negative impact on performance with respect to the target in a specific period. Performance data may be collected and stored periodically in the above twin hierarchical information structures.

At the end of each time period, such as quarterly for example, the initiative leader may record the occurrence all the observed risk factors corresponding to that time period. If a factor is not observed, it is assumed that the risk did not occur. From a business perspective, the initiative leaders may be so familiar with their initiatives they will be able to indicate definitively whether a specific risk has occurred. However, they may not observe the issue at the lowest level of the risk tree. In this case, risk occurrence may be recorded at the finest level of granularity in the risk tree that can be specified with confidence by the initiative leader. Due to the hierarchical nature of the taxonomy tree, a risk factor occurrence that is recorded at its finest granularity at some node, say, r, in a given tree, T, also has an implicit interpretation as an occurrence at each node in the ancestral path that leads upwards from node r to the root node of tree T, as illustrated in FIG. 5. This feature of the data enables analysis at any chosen level, or depth, in each tree. An initial taxonomy can continue to be refined over time to reflect new and changing categories of risk factors, as long as the historical data set of observations is mapped onto the updated taxonomy.

Initiative Descriptors

Certain types of projects exhibit a significant propensity for certain types of performance related risk factors. For example, examination of historical client delivery projects may indicate that those projects that relied on geographically dispersed delivery teams had a much higher rate of development-related negative risk factors. In this case, the makeup of the delivery team can be determined prior to the start of the initiative, and appropriate actions may be taken to mitigate the anticipated risk factor. In order to statistically learn such correlations, a relevant set of attributes with which each project may be characterized may be needed. In practice, the most useful set of such attributes for learning such correlations may not be self-evident. One may start with a multitude of attributes which are identified in discussions with SMEs. Predictive analytics may be used to identify a (sub)set of those attributes found to have a strong correlation with each observed risk factor in the taxonomy.

Performance Reporting and Risk Tracking

Performance reporting is a step in ensuring that all parties have access to the same information in the same format. For one type of example system, a set of reports may be defined providing different views of performance; both for individual initiatives and for portfolios of initiatives. Business analysts or initiative leaders who need to access detailed information regarding an initiative can view reports containing initiative-specific risks and mitigation actions, while business executives may prefer to see an overview of performance of a set of initiatives, by business unit or geography, for example.

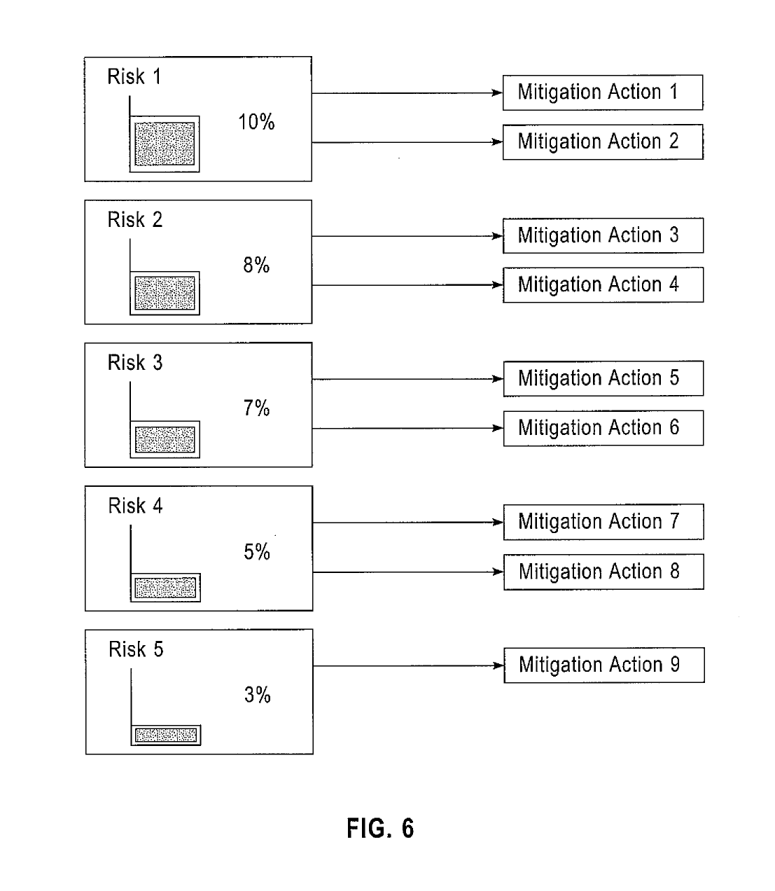

FIG. 6 provides an exemplary report for a specific initiative. The top five predicted risks, as measured according to potential impact on the target, are shown on the left side of the report, with the impact values depicted as horizontal bars. Recommended mitigation actions to address the top risks are shown on the right in list format. A business analyst or initiative leader might choose to view this report after observing that the initiative is expected to underperform against its target, for example, and would like to understand why and what might be done to prevent this from happening.

Risk status is included in reporting and is tracked over time. That is, on a regular basis, previously reported risks are reviewed by relevant stake holders—which risks are resolved and how, which risks remain influential and what has been/could be done to address the risks. As a result, best practices and lessons learned for addressing specific risks are systematically culled, providing various business benefits such as guiding mitigation planning. Additionally, the impact that any given risk factor exerts on a corresponding project performance metric is elicited each time period from subject matter experts, such as a delivery project executive in the case of client delivery projects. This step provides the data necessary to continuously improve the quantitative estimate of the collective impact of a set of anticipated risk factors on a new initiative. The impact values can be elicited either as weights indicating the percentage of the overall gap in a target metric attributable to a particular risk factor, or as values elicited in the same units as the target metric. In the first case, the weights are constrained to sum to 100%, whereas in the second case, the sum of the values must equal to the overall gap to target. We follow best practices on eliciting impact information from experts, so as to avoid bias effects. In cases where an expert does not feel confident about allocating the gap to specific risk factors, the impact can be uniformly distributed among them. Details on the use of these weights to compute initiative and portfolio impact estimates are presented in the Predictive Analytics and Software System section.

Risk Prediction and Issue Mitigation

For new initiatives, the structured data collected for completed or on-going projects is used to train predictive models to differentiate between initiatives and instances of risk occurrence based on initiative descriptors. Details of these models are discussed in the next section. Additionally, mitigation actions are captured and documented for reported risks. The evolving status of risks can be used to estimate the effectiveness of different mitigation actions, individually or in combination.

Predictive Analytics and Software System

A key part of the new approach is using data collected over time to identify patterns of risks arising for initiatives having particular characteristics and estimating the impact that these risks will have on the initiative, in terms of deviation from the initiative target. We describe here a two-step statistical modeling approach to address these questions. First, a risk likelihood model is used to estimate the likelihood of each risk factor in the taxonomy (at a specified level of the risk tree). A conditional impact model is then used to estimate the impact to the project metric attributable to each risk factor. The ‘expected net impact’ is computed as the product of the likelihood and the conditional impact. The following subsections detail the specifics of the models.

Likelihood Model

The first step estimates the likelihood of observing the occurrence of a specific risk factor over the lifetime of an initiative. Recall that each initiative is described in terms of a set of initiative descriptors. say, aᵢ=(aᵢ₁,aᵢ₂, . . . , a_{iN}), where N is the number of descriptors. Let R=∪ₖ₌₁^{k=K}{Tₖ⁺∪Tₖ⁻} denote the set of all possible risk factors. Across multiple historical projects Pᵢ, i∈I, and their respective multiple time periods of observation, t∈Hᵢ, the data set consists of observed occurrences of various risk factors. In other words, each record in our historical data set D consists of the combination,

d_{i,t}=(aᵢ,t,{δ_{i,t,r}=0/1}_{r∈R}), ∀i∈I,t∈Hᵢ

where δ_{i,t,r} takes value one or zero denoting occurrence/non-occurrence of risk factor r corresponding to project i in time period t. This information is recorded for every risk factor in the entire taxonomy. Note that each element in the set {δ_{i,t,r}=0/1}_{r∈R}, within each record, may represent an event observed at a specific level of the risk tree hierarchy or a hierarchically implied observation as explained using the example in FIG. 5. Ideally, one may want to predict the likelihood of a risk occurrence at any time interval in the tracking period. However, the potentially small number of initiatives for which there is historical data relative to the potentially large number of risks and initiative descriptors may make this impractical. We therefore focus on predicting the occurrence/non-occurrence of a risk factor in at least one time period during initiative tracking. The problem then collapses to a standard classification problem, i.e. for Yᵣ a random variable representing the occurrence or non-occurrence of risk r at least once during initiative tracking, estimate P(Yᵣ|aₖ) by analyzing a historical data set D′ where each record consists of the combination,

dᵢ′=(aᵢ,{δ_{i,r}=0/1}_{r∈R}), ∀i∈I

and δ_{i,r} takes value 1 if there is at least one time period where risk factor r was observed in initiative i. The output of the predictive model includes those deal descriptors that are most explanative of any given risk factor, thereby providing insight as to which initiative characteristics are important for predicting risks.

There are several techniques for addressing classification problems, such as decision-tree classifier, nearest-neighbor classifier, Bayesian classifier, Artificial Neural Networks, support vector machines and regression-based classification. In an example we chose to use a variant of decision-tree classifiers, namely the C5.0 algorithm that is available within IBM Statistical Package for the Social Sciences (SPSS). Our choice was partly motivated by our data set, which contains both categorical attributes and numerical attributes of varying magnitudes. Also, decision-trees may be interchangeably converted into rule sets that are typically easy to understand and further scrutinize from a descriptive modeling perspective for business analysts.

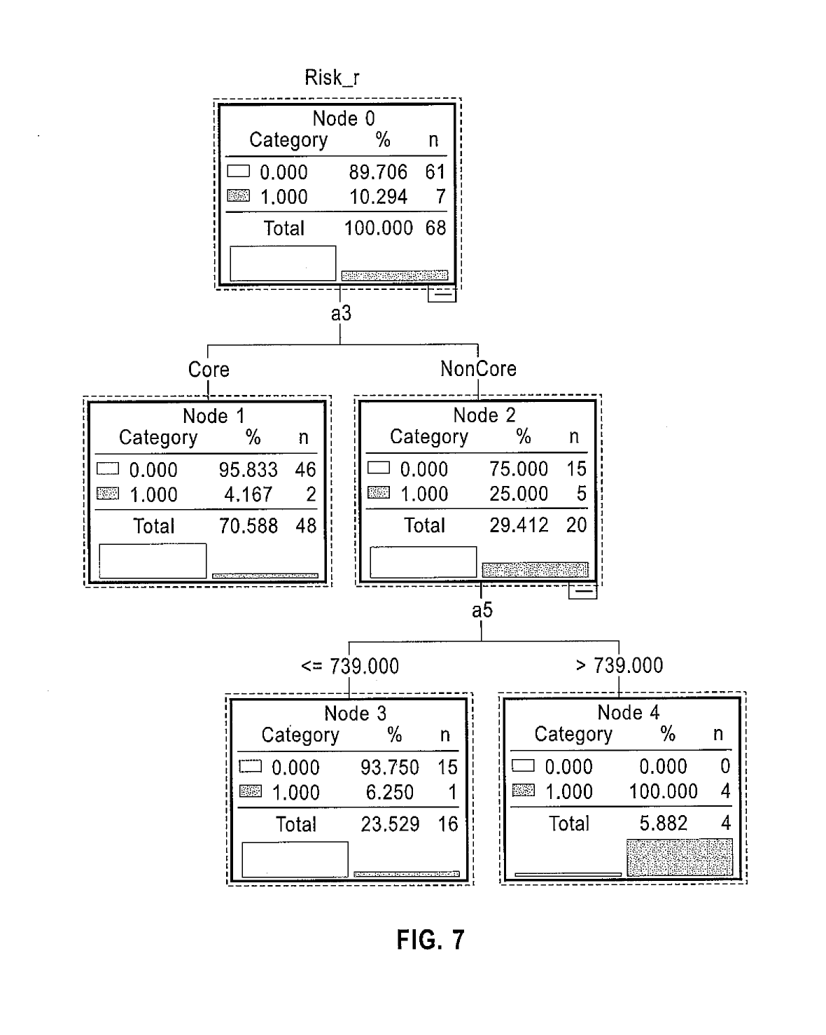

An example of a decision-tree is shown in FIG. 7 for an illustrative risk factor r, where the root node corresponds to a total of 68 historical training-set records. At the root node, the decision-tree uses a splitting test condition on a categorical attribute ‘a3’ that has two permissible values, namely ‘Core’ and ‘Noncore’, thus producing child nodes, Node 1 and Node 2, at the next level. Further, the tree uses a splitting test condition on a continuous numerical attribute ‘a5’ at Node 2, and produces child nodes, Node 3 and Node 4, thereby leading to a total of three partitions of the attribute space, i.e. three leaves, namely Node 1, Node 3 and Node 4. In a descriptive sense, risk factor r is explained by the categorical attribute ‘a3’ and the numerical attribute ‘a5’. For our example, we imposed structural constraints, e.g. a specified minimum number of training set records for each leaf of the induced decision-tree, to ensure that the trees were sufficiently small, easy to interpret, and not over fit. We also used the boosting ensemble classifier technique to improve the accuracy of classification. Assessing the predictive accuracy of the decision-tree model was done by systematically splitting the data into multiple testing and training sets using the standard technique of k-fold cross-validation (k=10 in our example). In our example, the overall accuracy of the likelihood models, as assessed using cross-validation, was around 88%.

We note that our approach assumes risk factors occur independently of each other, i.e. we build a decision-tree classifier for each risk factor independently of the others. More sophisticated approaches can be used to test for correlation among risks, i.e. one risk being more or less likely to occur in concert with another risk(s). However modeling occurrence/non-occurrence of combinations of risks rapidly becomes infeasible for small numbers of initiatives and large numbers of risks. Additionally, our approach builds a decision-tree classifier for each node within each tree in the taxonomy. Alternatively, we might constrain the decision-tree building algorithm across the various nodes within any given tree in the taxonomy to respect intra-tree hierarchical consistency. In other words, if the decision-tree predicts a particular class membership (occur/non-occur) for a given project attribute vector at a certain risk factor node, r, in any given tree, T, in the taxonomy, then the decision-trees corresponding to each ancestral node of r in tree T are also constrained to predict the same class membership given the same project attribute vector.

Impact Model

Assuming that a risk is likely to occur, the second step in our modeling approach is to estimate its potential impact on an initiative. Thus, we build a conditional impact model for each risk factor in the taxonomy. In other words, conditional on occurrence of the risk factor r in at least one time period t of initiative tracking, for a given project-attribute vector aₖ, we estimate impact, Δ(Yᵣ|aₖ) on the project metric of interest. Our approach is as follows. For each record in the historical data set D, we record a corresponding gap in the project metric, which is either a negative or a positive change relative to its ‘planned value’. The premise of our impact modeling analysis is that the observed gap in any record is the net consequence of all the risk factors that are observed for the same initiative. In general, the relationship between risk factors and the corresponding gap in the project metric is a complex relationship that may vary from project to project, as well as vary within the same project across time periods. We use a simplifying approach and assume an additive model, where the observed gap is additively decomposed into positive and negative individual contributions from the corresponding set of positive and negative risk factors. While it may be possible to fit a linear additive model and estimate the individual risk factor contributions from the data, it will be difficult to achieve accurate results based on only a small number of occurrences of each risk. Thus, we rely on input from initiative leaders, who provide an allocation of the total observed magnitude of the gap to the performance factors determined to have caused the gap. In other words, for any given data record, we have,

$${Δ}_{i , t} = {\sum }_{r ∈ {R}_{i , t}^{-}} {Δ}_{i , t , r}^{-} {δ}_{i , t , r} + {\sum }_{r ∈ {R}_{i , t}^{+}} {Δ}_{i , t , r}^{+} {δ}_{i , t , r} ,$$

where Δ_{i,t} denotes the observed gap in the target metric for project i in time period, t and the sets R_{i,t}⁻∈∪ₖ₌₁^{k=K}Tₖ⁻ and R_{i,t}⁺∈∪ₖ₌₁^{k=K}Tₖ⁺ denote the set of observed negative and positive performance factors at a particular level in the respective taxonomy trees.

The conditional impact attributable to any given risk factor is computed as a percentage impact relative to the planned value by averaging the corresponding percentages across all historical records. Percentage-based calculations are used to address the fact that historical projects typically differ significantly in terms of the magnitude of the target metric. More specifically, let m_{i,t} denote the target value for initiative i in time period t. Then the estimated conditional impacts (negative and positive) corresponding to the event Yᵣ are obtained as

$$Δ ( {Y}_{r} \vert {a}_{k} ) = Δ ( {Y}_{r} ) = \frac{{\sum }_{i ∈ I , t ∈ {H}_{i}} \frac{{Δ}_{i , t , r}^{-} {δ}_{i , t , r}}{{m}_{i , t}}}{{\sum }_{i ∈ I , t ∈ {H}_{i}} {δ}_{i , τ , r}} , \\ ∀ r ∈ {⋃}_{i ∈ I , t ∈ {H}_{i}} {R}_{i , t}^{-} , ∀ t$$

$$Δ ( {Y}_{r} \vert {a}_{k} ) = Δ ( {Y}_{r} ) = \frac{{\sum }_{i ∈ I , τ ∈ {H}_{i}} \frac{{Δ}_{i , τ , r}^{+} {δ}_{i , t , r}}{{m}_{i , τ}}}{{\sum }_{i ∈ I , τ ∈ {H}_{i}} {δ}_{i , τ , r}} , \\ ∀ r ∈ {⋃}_{i ∈ I , t ∈ {H}_{i}} {R}_{i , t}^{+} , ∀ t$$

The risk likelihood and conditional impact models are used in combination as follows. For any new attribute vector aₖ, the likelihood model is used to estimate the likelihood, P(Yᵣ|aₖ), of each risk factor node r at a specified level in each tree in the taxonomy. The conditional impact model is then used to estimate the impact on the target metric attributable to those same risk factor nodes. The ‘expected net impact’ is computed as the product of the likelihood and the conditional impact, i.e.

Δ̅ᵣ̅=P(Yᵣ|aₖ)·Δ(Yᵣ|aₖ).

While we recognize that this additive impact model does not account for interactions among risk factors that may occur in practice, additional data are needed to estimate interaction effects with any confidence. In the context of our simplified framework, however, interactions identified by an expert could be handled through extension of the risk taxonomy to add a new risk node, defined as the combination of the identified interacting factors, with conditional impact computed as outlined above. While in our example, the financial impact was obtained by averaging the corresponding percentages across all historical records, a subset of historical records could also be used to obtain an estimate of financial impact, where, for example, the subset is determined as that set of deals whose “fingerprints” correspond to the fingerprint found to correlate with occurrence of the specified performance factor.

The System

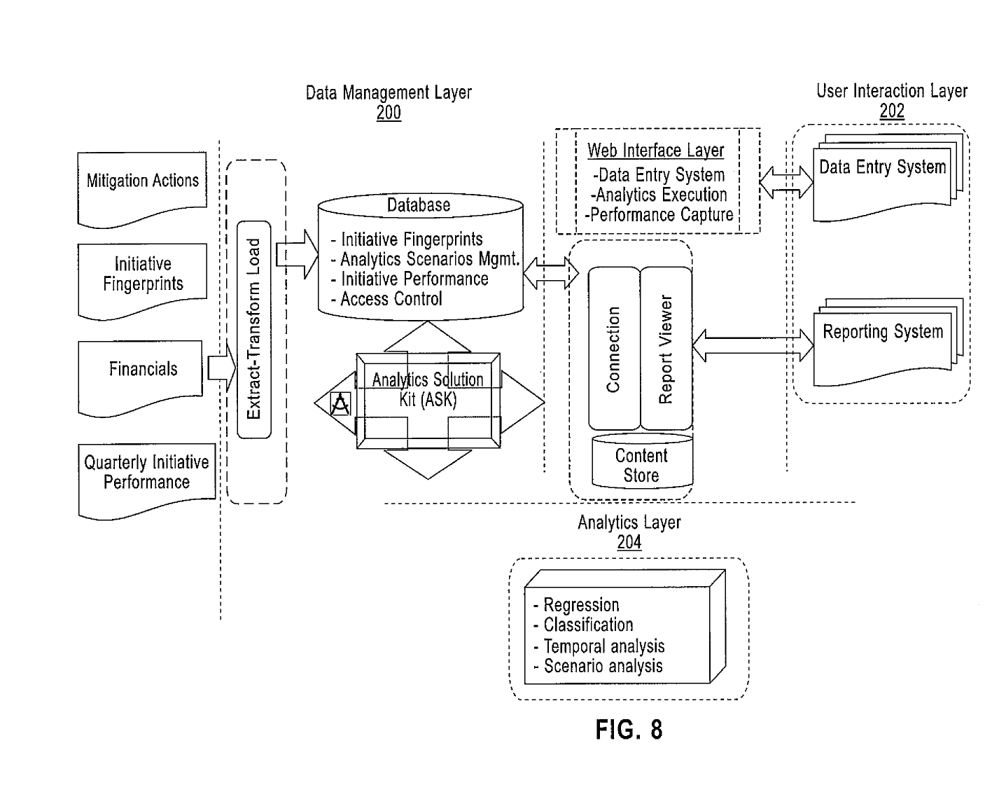

As part of risk management methodology, we have developed a system for use by the business initiative teams, enabling them to manage the end-to-end lifecycle of the process. The system consists of a 1) data layer 200, for sourcing and organizing information on the risk factors, deal descriptors, conditional impacts, and mitigations, 2) an analytics layer 202, to learn patterns of performance from historical initiatives and apply the learned patterns to predict risks that may arise in new initiatives and their expected impacts, and 3) a user-interaction layer 204, to provide individual and portfolio views of initiatives, as well as to capture input from users about new initiatives, observed impacts, and mitigation actions. FIG. 8 shows a sketch of an example system architecture built specifically to manage initiatives. The system may be built using commercial off-the-shelf products, including IBM WEBSPHERE PORTAL SERVER, DB2 DATABASE, COGNOS BUSINESS INTELLIGENCE, and SPSS MODELER. These products enable the enterprise system to meet both the security and scalability needs for the user.

From FIG. 8, we see that the data management layer 200 provides connectivity to the data sources supporting the risk management approach, and performs extract, transform, and load (ETL) functions to integrate data pulled from disparate data sources into a single source of truth. In other words, it validates, consolidates, and interconnects the information so that each data element is fully verifiable and consistent. For our application, data tables were carefully designed to build flexibility into the data layer and allow modifications and/or extensions to the risk taxonomy as the initiative sets evolve over time. The middle layer enables both the execution of the analytical models and the business intelligence reporting. The analytics rely on IBM SPSS for both re-training the risk occurrence models as new data becomes available each time period and for scoring new initiatives at the request of a business analyst. The conditional impact models were custom-built in Java. At the user interaction layer, the IBM COGNOS BUSINESS INTELLIGENCE product capabilities are used for report authoring and delivery, enabling drill down from, e.g., a portfolio analysis into details of a specific initiative.

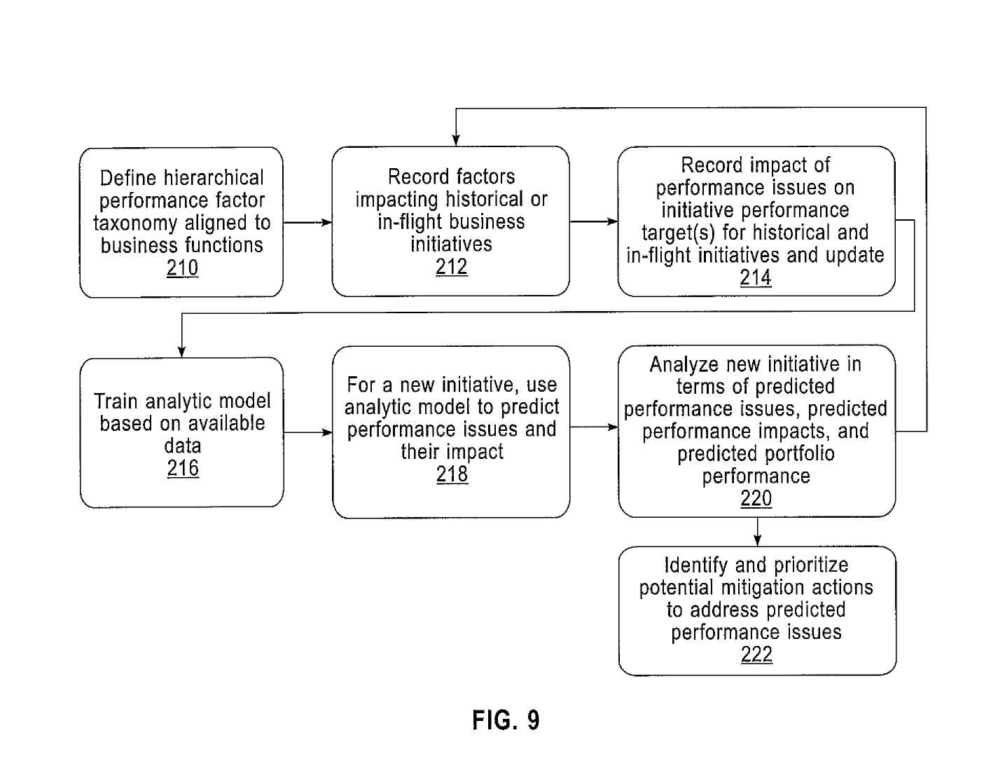

Features as described herein may be used with a systematic collection and analysis of data pertaining to initiative performance, including actions taken to control on-going performance, may be critical to enable more quantitative, fact-based and pro-active management of business initiatives. Referring also to FIG. 9, a method may be provided comprising the steps of:
Defining 210 performance factor taxonomy for business initiatives. This allows risks to be managed at different levels of detail in the hierarchy.
Recording 212 factors impacting historical or in-flight business initiatives
Recording 214 impact of performance issues on initiative performance target(s) for historical and in-flight initiatives and update. This uses a combination of prior assumptions and expert human input to apportion the observed total impact across Positive and Negative performance-factors, using a linear-additive breakdown.
Training 216 analytic model based on available data. A Multi-step modeling Approach may be used such as, for example:
   Build a predictive model (decision-tree model for example) to predict Likelihood of Performance-factors, as a function of deal-signature (or initiative signature)
   Build a linear model to estimate the conditional impact attributable to each performance-factor, respecting polarity (positive and negative signs)
   Combine the two models to predict expected net impact at the level of a new initiative, by summing over the product of probability and conditional impact of each positive and negative factor
For a new initiative, using 218 analytic model to predict performance issues and their impact
Analyzing 220 new initiative in terms of predicted performance issues, predicted performance impacts, and predicted portfolio performance
Identifying and prioritizing 222 potential mitigation actions to address predicted performance issues

Features may be oriented by integration function to drive actions. Multi-layer hierarchy provides increasing levels of granularity and provides a highly structured framework to rigorously identify and track business initiative issues. Features may use a business initiative “fingerprint” based upon prior similar business initiatives to identify, prioritize and recommend mitigation actions. The performance factor taxonomy may be structured according to business functions to enable appropriate mapping of performance improvement actions and responsibilities to specific performance factors. The performance factor taxonomy may have a hierarchical structure to allow capture and analysis of performance factors at most appropriate level of detail. A two-step methodology may be used to estimate performance impact from initiative descriptors, via prediction of performance issues. Features may be used to determine the probability and financial impact of potential business initiative performance factors by evaluating the business initiative “fingerprint” versus “fingerprints of prior business initiatives of a same type.

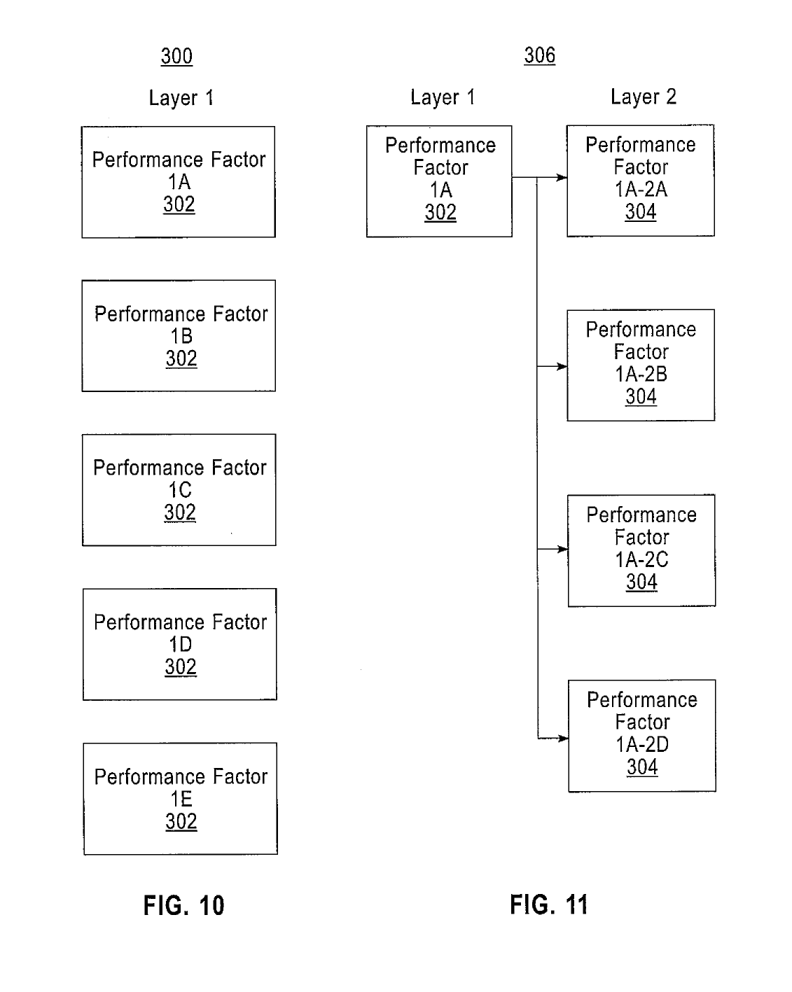

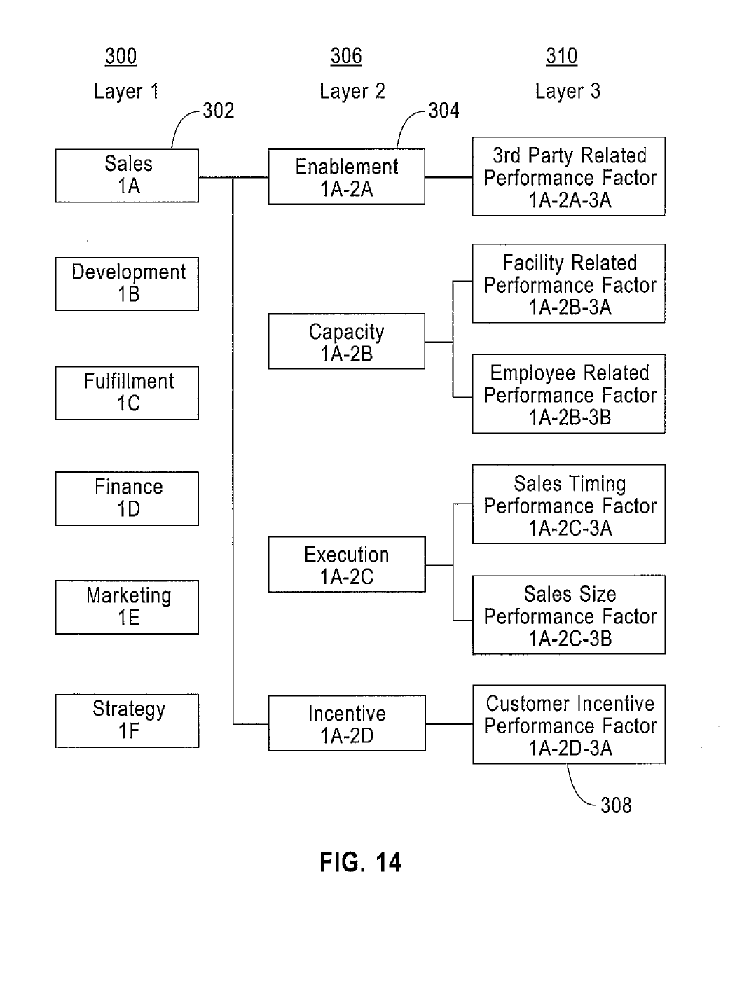

Referring also to FIG. 10, a first layer 300 of a hierarchical taxonomy of performance factors for a business initiative is shown. This example shows five (5) performance actors 302 labeled 1A-5A in this first layer. However, there may be more or less than five performance factors in this first layer. For example, FIG. 14 shows an example having six performance factors 302 in the first layer 300 labeled 1A-1F. In FIG. 14 the six performance factors in the first layer 300 are Sales, Development, Fulfillment, Finance, Marketing and Strategy. Any suitable identified performance factor for the specific business initiative may be identified. The business initiate may comprise, for example, acquiring or purchasing a company or merger of companies, launching a new product or service, launching a sales campaign, or any other suitable business initiative.

Referring also to FIG. 11, each of the first layer 300 performance factors 302 has one or more second layer performance factors 304 forming a second layer 306 of the hierarchical taxonomy. FIG. 11 merely shows the second layer performance factors for the first layer performance factor 1A. Each of the other first layer performance factors 302 have their own respective second layer performance factors, respectively. In FIG. 11 the first layer performance factor 1A has four (4) second layer performance factors 304 identified as 1A-2A, 1A-2B, 1A-2C and 1A-2D. More or less than four second layer performance factors may be provided. With reference to FIG. 14, for example, in this example embodiment the second layer performance factors for the first layer performance factor of Sales 1A comprise Enablement 1A-2A, Capacity 1A-2B, Execution 1A-2C and Incentive 1A-2D. These are all performance factors of the “Sales” performance factor.

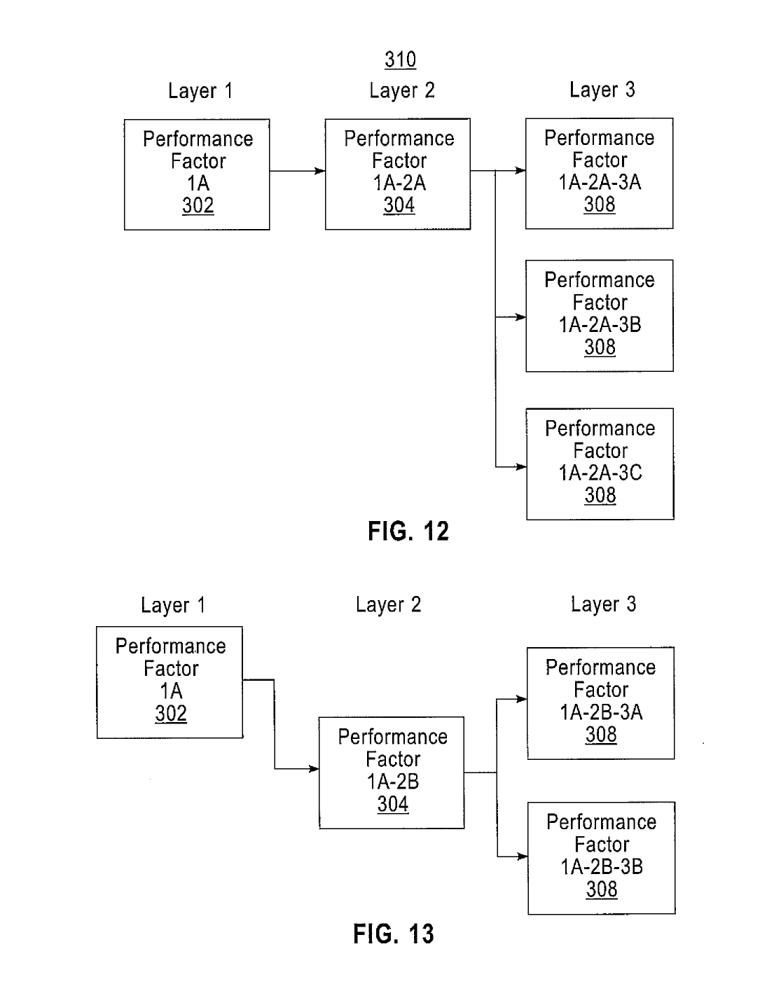

Referring also to FIG. 12, each of the second layer performance factors 304 has one or more third layer performance factors 308 forming a third layer 310 of the hierarchical taxonomy. FIG. 12 merely shows the third layer performance factors for the second layer performance factor 1A-2A. Each of the other second layer performance factors 304 (1A-2B, 1A-2C, 1A-2D) may have their own respective third layer performance factors, respectively. In FIG. 12 the second layer performance factor 2A has three (3) third layer performance factors 308 identified as 1A-2A-3A, 1A-2A-3B and 1A-2A-3C. More or less than three third layer performance factors may be provided. With reference to FIG. 14, for example, in this example embodiment the third layer performance factors for the second layer performance factors 306 comprise a 3^{rd} Party Related Performance Factor 1A-2A-3A for Enablement 1A-2A, a Facility Related Performance Factor 1A-2B-3A and Employee Related Performance Factor 1A-2B-3B′ for Capacity 1A-2B, Sales Timing Performance Factor 1A-2C-3A and Sales Size Performance Factor 1A-2C-3B for Execution 1A-2C and Customer Incentive Performance Factor 1A-2D-3A for Incentive 1A-2D. More or less than three layers 300, 306, 310 may be provided, and the layers stemming off of each first layer performance factor 300 may not have the same amount of layers. For example, while Sales 1A is shown with three layers, Development may have more or less than three layers of performance factors. Likewise, the other deeper layers of the hierarchical taxonomy do not need to have a same number of sub layers. As another example, referring also to FIG. 13, performance factor 1A has a sub-layer performance factor 1A-2B which has two sub-layers 1A-2B-3A and 1A-2B-3B.

For the hierarchical taxonomy of the performance factors, each deeper layer is a sub-layer of a performance factor of the higher layer. As noted above, initially to help establish the hierarchical taxonomy anticipated performance factors are identified (such as risks) and may be leveraged based upon prior experience. The performance factors may be assigned to one or more teams of people to address. Validated performance factors and mitigation actions may flow directly into periodic tracking, such as quarterly tracking for example. Performance factors and mitigation actions may be tracked on a business initiative by business initiative basis.

The process may comprise determining impact of performance factors with the use of hierarchical taxonomy modeling where performance factors are captured at different levels or layers of the hierarchy. For example, at the highest level there may be simple development performance factors, a lower level may comprise resources for those development performance factors, and a loser level may comprise skills. However, collection of data for the lower levels may be sparse, such that there is not enough data for good modeling. In that situation, the hierarchical nature of the taxonomy allows the performance factors to be aggregated up to a different higher level in the tree. For the example shown in FIG. 12 if not enough data for good modeling is contained in layer 3 310, then the data from 1A-2A-(3A-3C) may be aggregated up to performance factor 1A-2A. Thus, a very detailed the taxonomy may be used, even without very deep level data, because of the hierarchical nature of the taxonomy, thereby adjusting granularity.

For any business initiative, this may be applied to identify and quantify business initiatives post-close, used for anticipation for new and in-process business initiatives, and to also manage portfolios. For example, for post-close business initiatives, analysis and analytics may comprise identifying initiative execution performance factors and root causes, and their impact on initiative performance, and capture up to date lessons learned from initiative execution teams. This may produce insights that generate quantifiable explanation of what happened in a time period and allows for comparison across initiatives, and real-time feedback on mitigation actions and best practices being driven by initiative execution teams. For new and in-process business initiatives, analysis and analytics may comprise anticipation of potential execution risks and estimation of their Revenue impact based on initiative characteristics. This may produce implications to initiative prioritization, cost estimation, staffing and execution, leveraging new lessons learned each quarter. For management business initiatives, analysis and analytics may comprise identifying cross-company and within-function execution performance trends and quantifying their impact on initiative and portfolio Revenue performance. This may produce implications to encourage fact-based, analytically driven business discussions about key drivers of performance, and identify and manage performance factors from initiative concept approval through execution.

Features as described herein may provide:
Defined taxonomy and process to systematically categorize and capture performance factors impacting business initiative performance (such as an acquisition by a company for example)
Novel statistical models based on historical data for predicting potential business initiative negative and positive performance factors (such as acquisition during an integration business initiative)
Standardized methodology for estimating financial impact of different performance factors of the business initiative
An enterprise system to bring together descriptive and predictive analytics into a seamless business initiative risk and performance management solution

For a business initiative, for example, analytic components may comprise:
Core set of statistical models to predict business performance factors and estimate their potential financial impact, at an individual initiative and an initiative portfolio level
   Boosted hierarchical classification trees to predict and prioritize performance factors as a function of initiative descriptor combinations that can be applied at any level of the performance factor hierarchy
   Regression methods updated with expert-specified weights to link performance factors to financial performance
Comprehensive reports, such as with the use of business intelligence and financial performance management software, such as COGNOS from International Business Machines Corporation for example, to provide views of predicted performance factors, financial impacts, and mitigation actions
   Individual initiative views of predicted high impact performance factors
   Portfolio views of expected financial performance
   Temporal views of deal performance factors over the initiative execution time period
   Suggested mitigation actions

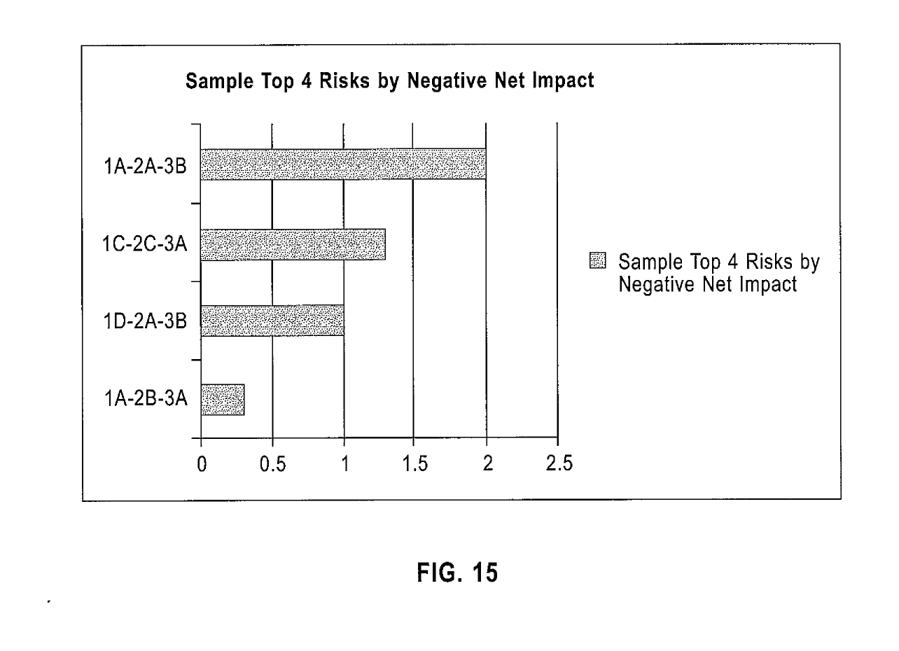

For example, referring also to FIG. 15, an example of a report of the top 4 risks by negative net impact from the examples of 10-14 is shown.

The method may include estimating the financial impact to revenue (relative to planned revenue) by learning a nonlinear model using the deal-descriptors (or project fingerprint variables) as the covariates and the Actual Revenue impact as the dependent variable, by training such a model on historical data of projects (their respective fingerprint covariate variables, and their respective actual Revenue Impact). There may be specialization, where such a model is a Classification and Regression Tree model. There may be specialization, where such a model is a Nearest-Neighbor model that is trained using metric learning.

An example method may comprise, for a business initiative, determining key negative and positive performance factors by a computer from a structured taxonomy of negative and positive performance factors stored in a memory, and modeling the key negative and positive performance factors by the computer, where the key negative and positive performance factors are modeled based, at least partially, upon a likelihood of occurrence of the key negative performance factors during the business initiative, and based, at least partially, upon potential impact of the key performance factors on the business initiative; and providing the modeled performance factors in a report to a user, where the report identifies the negative performance factors, and identifies the positive performance factors which may at least partially offset the negative performance factors.

The modeling may be based, at least partially, upon financial impact of the performance factors on the business initiative. The modeling may be based, at least partially, upon prioritizing the performance factors based upon their financial impact on the business initiative. The method may further comprise, before the determining and modeling, creating the structured taxonomy of negative and positive performance factors based, at least partially, upon a historical review of at least one prior similar business initiative. The modeling may comprise linking at least one mitigation action to at least one of the negative performance factors. The method may further comprise prioritizing the mitigation actions based, at least partially, upon to financial impact of the mitigation actions on the business initiative.

An example apparatus may comprise at least one processor; and at least one memory including computer program code, the at least one memory and the computer program code configured to, with the at least one processor, cause the apparatus at least to, for a business initiative, determine key negative and positive performance factors from a structured taxonomy of negative and positive performance factors stored in the memory, and model the key negative and positive performance factors based, at least partially, upon a likelihood of occurrence of the key negative performance factors during the business initiative, and based, at least partially, upon potential impact of the key performance factors on the business initiative; and provide the modeled performance factors in a report to a user, where the report identifies the negative performance factors, and identifies the positive performance factors which may be used to at least partially offset the negative performance factors.

The model may be based, at least partially, upon financial impact of the performance factors on the business initiative. Alternatively, or additionally, the model may be based, at least partially, upon resources and/or customer satisfaction. The model may be based, at least partially, upon prioritizing the performance factors based upon their financial impact on the business initiative. The apparatus may be configured to create the structured taxonomy of negative and positive performance factors based, at least partially, upon a historical review of at least one prior similar business initiative. The model may comprise linking at least one of the mitigation actions to at least one of the negative performance factors. The positive performance factors may comprise mitigation actions which may be used to at least partially offset the negative performance factors in regard to financial impact of the negative performance factors on the business initiative. The mitigation actions may be prioritized based, at least partially, upon to financial impact of the mitigation actions on the business initiative.

An example non-transitory program storage device readable by a machine may be provided, tangibly embodying a program of instructions executable by the machine for performing operations, the operations comprising for a business initiative, determining key negative and positive performance factors by a computer from a structured taxonomy of negative and positive performance factors stored in a memory, and modeling the key negative and positive performance factors by the computer, where the key negative and positive performance factors are modeled based, at least partially, upon a likelihood of occurrence of the key negative performance factors during the business initiative, and based, at least partially, upon potential impact of the key performance factors on the business initiative; and providing the modeled performance factors in a report to a user, where the report identifies the negative performance factors, and identifies the positive performance factors which may be used to at least partially offset the negative performance factors. The model may be based, at least partially, upon financial impact of the performance factors on the business initiative.

Any combination of one or more computer readable medium(s) may be utilized as the memory. The computer readable medium may be a computer readable signal medium or a computer readable storage medium. A computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

An example method may comprise, for a set of historical and/or ongoing business initiatives, determining key negative and positive performance factors by a computer from a structured taxonomy of negative and positive performance factors stored in a memory, where the structured taxonomy is a hierarchical taxonomy; modeling at least one of the key negative and positive performance factors for the ongoing business initiative or a new business initiative by the computer at at least one level of the hierarchical taxonomy based, at least partially, upon a likelihood of occurrence of the key performance factors during the business initiative, and potential impact of the key performance factors on the business initiative; and providing at least one of the modeled performance factors in a report to a user, where the report identifies the at least one modeled performance factor, and the potential impact of the at least one modeled performance factor.

An example apparatus may comprise at least one processor; and at least one non-transitory memory including computer program code, the at least one memory and the computer program code configured to, with the at least one processor, cause the apparatus at least to, for a set of historical and/or ongoing business initiatives, determine key negative and positive performance factors from a structured taxonomy of negative and positive performance factors stored in the memory, where the structured taxonomy is a hierarchical taxonomy; model at least one of the key negative and positive performance factors for the ongoing business initiative or a new business initiative at at least one level of the hierarchical taxonomy based, at least partially, upon a likelihood of occurrence of the key performance factors during the business initiative, and potential impact of the key performance factors on the business initiative; and provide at least one of the modeled performance factors in a report to a user, where the report identifies the at least one of the modeled performance factor, and the potential impact of the at least one modeled performance factor.

An example embodiment may be provided in a non-transitory program storage device readable by a machine, tangibly embodying a program of instructions executable by the machine for performing operations, the operations comprising, for a set of historical and/or ongoing business initiatives, determining key negative and positive performance factors by a computer from a structured taxonomy of negative and positive performance factors stored in a memory, where the structured taxonomy is a hierarchical taxonomy; modeling at least one of the key negative and positive performance factors for the ongoing business initiative or a new business initiative by the computer at at least one level of the hierarchical taxonomy based, at least partially, upon a likelihood of occurrence of the key performance factors during the business initiative, and potential impact of the key performance factors on the business initiative; and providing at least one of the modeled performance factors in a report to a user, where the report identifies the at least one modeled performance factor, and the potential impact of the at least one modeled performance factor.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A method comprising:
for a set of historical and/or ongoing business initiatives, determining key negative and positive performance factors by a computer from a structured taxonomy of negative and positive performance factors stored in a memory, where the structured taxonomy is a hierarchical taxonomy;
modeling at least one of the key negative and positive performance factors for the ongoing business initiative or a new business initiative by the computer at at least one level of the hierarchical taxonomy based, at least partially, upon:
a likelihood of occurrence of the key performance factors during the business initiative, and
potential impact of the key performance factors on the business initiative; and
providing at least one of the modeled performance factors in a report to a user, where the report identifies:
the at least one modeled performance factor, and
the potential impact of the at least one modeled performance factor.

2. The method of claim 1 where the modeling is based, at least partially, upon predicted financial impact of the performance factors on the business initiative.

3. The method of claim 2 where the modeling is based, at least partially, upon prioritizing the performance factors based upon their financial impact on the business initiative.

4. A method as in claim 1 further comprising, before the determining and modeling, creating the structured taxonomy of negative and positive performance factors based, at least partially, upon a historical review of at least one prior similar business initiative.

5. A method as in claim 1, where at least one mitigation action is associated with at least one of the negative performance factors determined for a business initiative, and the financial impact of the mitigation action is determined.

6. A method as in claim 5 where the modeling comprises linking at least one historical mitigation action to at least one of the negative performance factors.

7. A method as in claim 6 further comprising prioritizing the at least one historical mitigation action based, at least partially, upon predicted financial impact of the at least one historical mitigation action on the business initiative.

8. A method as in claim 1 further comprising estimating a financial impact to revenue relative to a planned revenue by learning a nonlinear model using project fingerprint variables as the covariates and the actual revenue impact as the dependent variables.

9. An apparatus comprising
at least one processor;
and at least one non-transitory memory including computer program code,
the at least one memory and the computer program code configured to, with the at least one processor, cause the apparatus at least to:
for a set of historical and/or ongoing business initiatives, determine key negative and positive performance factors from a structured taxonomy of negative and positive performance factors stored in the memory, where the structured taxonomy is a hierarchical taxonomy;
model at least one of the key negative and positive performance factors for the ongoing business initiative or a new business initiative at at least one level of the hierarchical taxonomy based, at least partially, upon:
a likelihood of occurrence of the key performance factors during the business initiative, and
potential impact of the key performance factors on the business initiative; and
provide at least one of the modeled performance factors in a report to a user, where the report identifies:
the at least one of the modeled performance factor, and
the potential impact of the at least one modeled performance factor.

10. An apparatus as in claim 9 where the model is based, at least partially, upon predicted financial impact of the performance factors on the business initiative.

11. An apparatus as in claim 10 where the model is based, at least partially, upon prioritizing the performance factors based upon their financial impact on the business initiative.

12. An apparatus as in claim 9 where the apparatus is configured to create the structured taxonomy of negative and positive performance factors based, at least partially, upon a historical review of at least one prior similar business initiative.

13. An apparatus as in claim 9 where the apparatus is configured to associate at least one mitigation action with at least one of the negative performance factors for the business initiative, and determine the financial impact of the mitigation action.

14. An apparatus as in claim 9 where the model comprises linking at least one historical mitigation action to at least one of the negative performance factor.

15. An apparatus as in claim 14 where the apparatus is configured to prioritize the mitigation actions based, at least partially, upon financial impact of the at least one historical mitigation action on the business initiative.

16. A non-transitory program storage device readable by a machine, tangibly embodying a program of instructions executable by the machine for performing operations, the operations comprising:
for a set of historical and/or ongoing business initiatives, determining key negative and positive performance factors by a computer from a structured taxonomy of negative and positive performance factors stored in a memory, where the structured taxonomy is a hierarchical taxonomy;
modeling at least one of the key negative and positive performance factors for the ongoing business initiative or a new business initiative by the computer at at least one level of the hierarchical taxonomy based, at least partially, upon:
a likelihood of occurrence of the key performance factors during the business initiative, and
potential impact of the key performance factors on the business initiative; and
providing at least one of the modeled performance factors in a report to a user, where the report identifies:
the at least one modeled performance factor, and
the potential impact of the at least one modeled performance factor.

17. An device as in claim 16 where the model is based, at least partially, upon predicted financial impact of the at least one of the performance factors on the business initiative.
